(19) United States
(12) Patent Application Publication
(10) Pub. No.: US 2013/0191774 A1
(43) Pub. Date: Jul. 25, 2013

(54) METHOD AND APPARATUS FOR EXECUTING APPLICATION FILE AND SCREEN CAPTURE METHOD AND APPARATUS THEREFOR

(71) Applicant: Samsung Electronics Co., Ltd., Gyeonggi-do (KR)

(72) Inventors: Young-Ju CHOI, Gyeonggi-do (KR); Jae-Yoel PARK, Gyeonggi-do (KR)

(73) Assignee: SAMSUNG ELECTRONICS CO., LTD., Gyeonggi-do (KR)

(21) Appl. No.: 13/738,328

(22) Filed: Jan. 10, 2013

(30) Foreign Application Priority Data
Jan. 19, 2012 (KR) 10-2012-0006089

(51) Int. Cl. G06F 3/0481

(52) U.S. Cl. CPC G06F 3/0481
USPC 715/781

(57) ABSTRACT

A method and apparatus for executing application file and a screen capture method and apparatus therefor are provided, in which a screen that is being displayed is captured and stored in a file in response to screen capture request, and execution state information about an application file corresponding to at least one application window included in the captured screen is stored in the file.

### CLAIM OF PRIORITY

This application claims priority under 35 U.S.C. §119(a) to a Korean Patent Application filed in the Korean Intellectual Property Office on Jan. 19, 2012 and assigned Serial No. 10-2012-0006089, the contents of which are incorporated herein by reference.

### BACKGROUND OF THE INVENTION

1. Field of the Invention

The present invention relates to a method and apparatus for capturing a screen being displayed on a display.

2. Description of the Related Art

A screen capture function is generally used in mobile terminals such as smart phones as well as desktop computers and laptop computers. A user can capture an image of screen being displayed on a computer screen or a mobile terminal screen using the screen capture function which is stored in an image file. Here, the screen capture function is used simply as a function of memorizing static visual information displayed thereon at a particular time.

Thereafter, the user may view the captured image stored in the image file. However, the screen capture function currently does not provide other functions other than simply capturing, storing and viewing the image.

### SUMMARY OF THE INVENTION

An aspect of embodiments of the present invention is to provide a method and apparatus for executing an application file corresponding to information being displayed through a screen capture scheme.

Another aspect of embodiments of the present invention is to provide a method and apparatus for executing an application file corresponding to information being displayed, wherein a previously stored image of a screen can be retrieved from a memory upon a request, and simultaneously at least one application corresponding to at least one open window displayed in the previously stored screen is automatically activated.

In accordance with an embodiment of the present invention, there is provided a screen capture method in which a screen that is being displayed is captured and stored in a file in response to a screen capture request, wherein execution state information about an application file corresponding to at least one application window included in the captured screen is stored in the file.

In accordance with another embodiment of the present invention, there is provided a screen capture apparatus having a display and a memory for executing an application file, wherein a processor captures a screen that is being displayed on the display and stores the captured screen in a file in the memory in response to a screen capture request, and also stores execution state information about an application file corresponding to at least one application window included in the captured screen in the file.

In accordance with another embodiment of the present invention, there is provided a method for executing an application file, in which a request for executing a file having execution state information is received, and at least one application file is executed according to the execution state information stored in the file.

In accordance with a further embodiment of the present invention, there is provided an apparatus for executing an application file, in which a memory stores a file having execution state information, and a processor executes at least one application file according to the execution state information, upon request of executing the file having the execution state information.

### BRIEF DESCRIPTION OF THE DRAWINGS

The above features and advantages of certain embodiments of the present invention will be more apparent from the following detailed description taken in conjunction with the accompanying drawings, in which:

FIG. 1 is a block diagram of a screen capture apparatus for executing an application file according to an embodiment of the present invention;

FIG. 2 is a flowchart illustrating a screen capture method for executing an application file according to an embodiment of the present invention;

FIG. 3 illustrates an exemplary captured screen according to an embodiment of the present invention;

FIG. 4 is a diagram illustrating an image file structure for executing an application file according to an embodiment of the present invention; and

FIG. 5 is a flowchart illustrating an operation for executing an application file according to an embodiment of the present invention.

Throughout the drawings, the same drawing reference numerals will be understood to refer to the same elements, features and structures.

### DETAILED DESCRIPTION OF EMBODIMENTS OF THE INVENTION

Reference will be made to preferred embodiments of the present invention with reference to the attached drawings. For simplicity and clarity, a detailed description of a generally known function and structure of the present invention will be avoided not to obscure the subject matter of the present invention. The terms described below are defined in connection with the function of the present invention. The meaning of the terms may vary according to the user, the intention of the operator, usual practice, etc. Therefore, the terms should be defined based on the description.

While embodiments of the present invention are described in the context of a mobile terminal, it is purely exemplary and illustrative purposes. Thus, it is to be understood that the embodiments of the present invention are also applicable to other devices, such as a mobile terminal such as a smart phone as well as a desktop computer, a laptop computer, or a tablet PC, having a similar technological background that allows executing of an application file through screen capture. In addition, those skilled in the art can implement the embodiments of the present invention for other devices through modifications within the scope and spirit of the present invention.

While a text file, a multimedia content file, and an application program execution file are taken as exemplary application files in describing the embodiments of the present invention, it is to be understood that the embodiments of the present invention can be implemented for other application files having a similar technological background that allows executing of the application files through screen capture.

Further, while at least one application window is being displayed, a user may capture a screen, store the captured screen in an image file, and later can view information about an application file corresponding to information being displayed at a screen capture time from the captured image in the image file. The application file may be an execution file for executing an application program having a specific function as well as a data file such as a text file or a multimedia content file.

Briefly, when a user operates the screen capture function, an application file corresponding to information that was being displayed at a previous screen capture time may be detected from a captured screen image in an image file and then executed. For example, if the application file is a text file, a page displayed at the screen capture time is opened so that the user can do paperwork. If the application file is a multimedia content file, multimedia content may be reproduced starting from a position played at the screen capture time. If the application file is an application program execution file, an associated application program may be executed.

Also, when user wants to check and execute an application file corresponding to information that was being displayed at a screen capture time from a captured screen image, the user may have to search for the application file and execute it on his or her own. If the user does not remember a correct file path to the application file, the user may have difficulty in finding the application file. If a plurality of application windows were being displayed at the screen capture time and the user wants to execute associated application files, the difficulty and inconvenience may be increased.

Therefore, the present invention is intended to enable executing of an application file corresponding to information that was being displayed at a screen capture time moment simply by executing a captured screen image file, without the need for a user to search for the application file on his or her own and then to execute it.

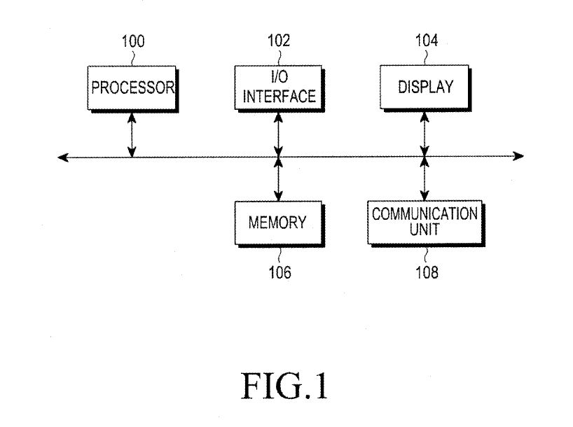

FIG. 1 is a block diagram of a screen capture apparatus for executing an application file according to an embodiment of the present invention. The present invention is applied to a mobile terminal, by way of example.

Referring to FIG. 1, a processor 100 performs screen capture for executing an application file and executes an application file through screen capture, as well as performs a normal mobile terminal function.

When a user requests screen capture by entering a screen capture command through an Input/Output (I/O) interface 102, the processor 100 captures a screen that is being displayed on a display 104 and then stores the captured screen in a memory 106. Preferably, a file in which the captured screen is stored is an image file so that the user may view images included in image files through an image viewer and easily select an image file associated with an intended application to be executed from among the image files.

The I/O interface 102 provides a user interface for user input to and user output from the processor 100. The memory 106 stores an image file of captured screens, programs executed by the processor 100, files executed by the processor 100, and data resulting from program execution of the processor 100. The memory 106 may further include an external memory. In addition, the memory 106 may also include a storage device such as a Hard Disk Drive (HDD). A communication unit 108 conducts communication for voice and data communication functions executed by the processor 100.

If information about one or more executed application files are being displayed at a moment when the screen is captured, the captured screen includes an application window corresponding to each of the executed application files. Then, the processor 100 stores execution state information about the application files corresponding to the application windows included in the captured screen in an image file of the captured screen. Notably, the processor 100 adds the execution state information to the image file, when storing it.

Thereafter, when the user requests executing of the image file including the execution state information through the I/O interface 102, the processor 100 executes an application file according to the execution state information. Therefore, the application file corresponding to information that was being displayed at the screen capture time is executed so that the user can resume back a previously stored screen without searching and executing the needed application.

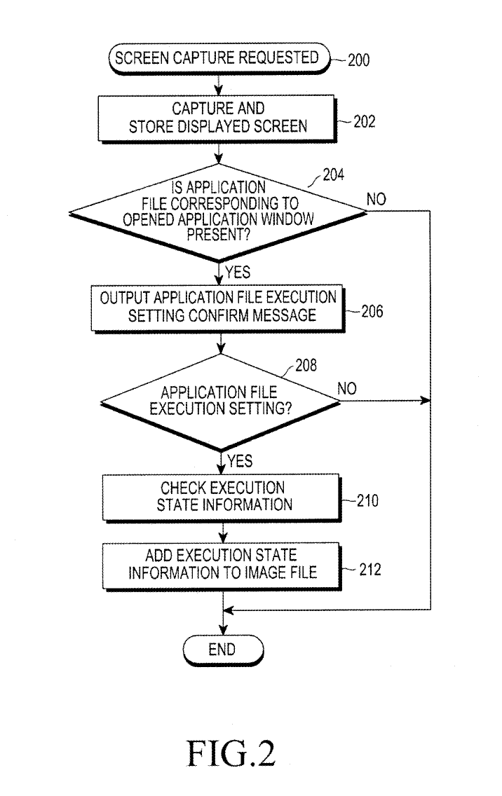

FIG. 2 is a flowchart illustrating a screen capture method for executing an application file according to an embodiment of the present invention.

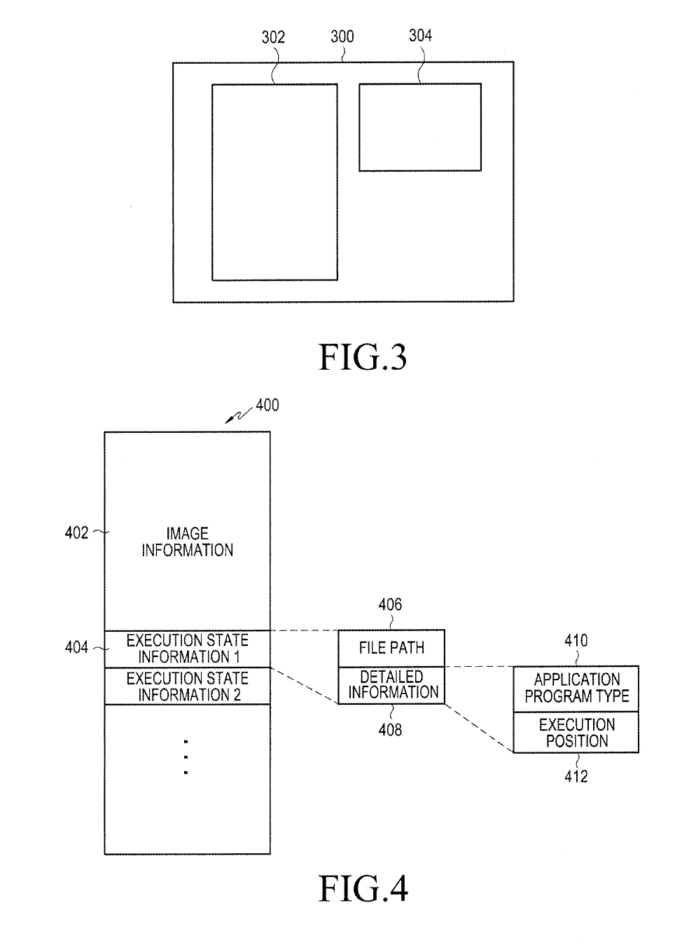

Referring to FIG. 2, when a user requests screen capture by entering a screen capture command through the I/O interface 102 in step 200, the processor 100 captures a screen being displayed on the display 104 and stores the captured screen in an image file in the memory 106 in step 202 and goes to step 204. If one or more application files such as text files, multimedia content files, or application program execution files are executed at that moment, the captured screen includes opened application windows as illustrated in FIG. 3.

FIG. 3 illustrates an example of a captured screen 300 including two application windows 302 and 304. In operation, the two application windows 302 and 304 corresponding to two application files executed at a screen capture time are included in the captured screen 300. Moreover, while the two application windows 302 and 304 are included in the captured screen 300 in the illustrated example of FIG. 3, if more application files were executed at the moment of activating a screen capture function, application windows corresponding to the respective executed application files are included in the captured screen 300.

The application windows 302 and 304 may be for application files of the same type. For example, the application windows 302 and 304 may be different two text files, multimedia content files, or application program execution files, or any combination thereof. Also, the application windows 302 and 304 may be for application files of different application types. For example, the application window 302 may be for a text file, and the application window 304 may be for an application program execution file. In another example, the application window 302 may be for a text file, and the application window 304 may be for a multimedia content file. Thus, the application window 302 may include an image of an opened text page, and the application window 304 may include an image of reproduced multimedia content. If reproduction of the multimedia content is stopped or paused, the application window 304 may include an image of the stopped or paused multimedia content.

In step 204, the processor 100 determines whether any application file corresponding to an opened application window 302 or 304 exists, as illustrated in FIG. 3. In the absence of an application file corresponding to an opened application window, the processor 100 ends the procedure. However, in the presence of an application file corresponding to an opened application window, the processor 100 outputs an application file execution setting confirm message in step 206 and determines whether the user selects application file execution setting in step 208. Even though there is an application file corresponding to an opened application window, the user may have intended simply to store a general screen capture without the need to execute the application file later. To achieve this, the application file execution setting confirm message is displayed on the display 104, inquiring the user whether to implement a setting for executing the application file later in relation to an image file of a captured screen. Therefore, the application file execution setting confirm message may include, for example, a message asking whether to set application file execute and a button with which to select “Yes” or “No”.

If the user does not select the application file execution setting in step 208, the processor 100 ends the procedure. On the other hand, if the user selects the application file execution setting in step 208, the processor 100 checks execution state information in response to the user selection in step 210 and adds the execution state information to the image file for storage in step 212. The execution state information is used to execute an application file corresponding to an application window included in the captured screen later, thus includes information about a file path to the application file and other detailed information about the application file. The detailed information about the application file indicates an application program type of the application file. If the application file is a text file or a multimedia content file, the detailed information further indicates an execution position of the file.

The processor 100 checks the execution state information by extracting information about the file path, application program type, and execution position of the application file corresponding to the application window included in the captured screen in step 210. The file path specifies a position at which the application file is stored and the name of the application file. The application program type identifies an application program connected to the application file. If the application file is a text file, the execution position indicates a page opened at the screen capture time. If the application file is a multimedia content file, the execution position indicates the reproduced position of the file at the screen capture time.

FIG. 4 is a diagram illustrating an image file structure for executing an application file according to an embodiment of the present invention. As shown an image file 400 added with execution state information includes image information 402 corresponding to a captured screen, and execution state information 404 added to the image information 402. Therefore, an application file execution setting is implemented by adding the execution state information 404 to the image information 402 of the captured screen in step 210. If a plurality of application windows is included in the captured screen, the execution state information 404 is added for each of application files corresponding to the application windows. That is, execution state information 1, execution state information 2, . . . are added for the respective application files. Execution state information corresponding to each application file includes a file path 406 and detailed information 408, and the detailed information 408 specifies an application program type 410. If the application file is a text file or a multimedia content file, the detailed information 410 further specifies an execution position 412.

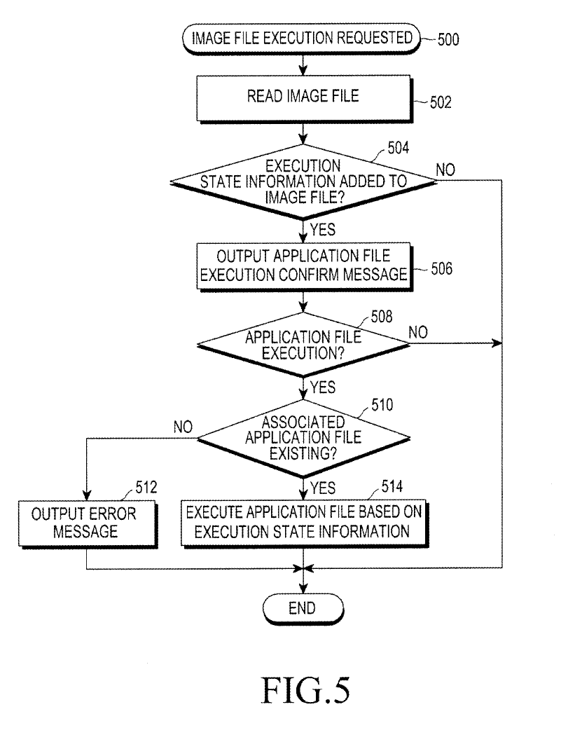

FIG. 5 is a flowchart illustrating an operation for execution an application file according to an embodiment of the present invention. As shown, when a user requests executing of an image file stored in the memory 106 on an image viewer through the I/O interface 102 in step 500, the processor 100 reads the image file in step 502 and determines whether execution state information is added to the image file in step 504. If the requested image file is a general image file without the execution state information included therein, the processor 100 ends the procedure. Herein, the user may view an image of each image file on the image viewer and select an image file related to an intended application file to be executed.

In contrast, if the requested image file is added with the execution state information according to the embodiment of the present invention, the processor 100 outputs an application file execution confirm message in step 506 and monitors whether the user selects to execute the application file in step 508. Even though the image file is added with the execution state information, the user may want to simply view an image of the image file later. Thus, the application file execution confirm message is displayed on the display 104, asking the user whether to execute the application file according to the execution state information added to the image file. Alternatively, a default can be set to execute the intended application automatically without requesting a user's confirmation, when the user requests executing of the image file added the execution state information. Thus, the application file execution confirm message may include, for example, a message asking whether to execute the application file and a button with which to select “Yes” or “No”.

If the user does not select to execute the application file, the processor 100 ends the procedure. On the other hand, if the user selects to execute the application file, the processor 100 determines whether an application file corresponding to a file path specified by the execution state information exists in the memory 106 in step 510. In the absence of the application file, the processor 100 outputs an error message in step 512 and ends the procedure.

In the presence of the application file in step 510, the processor 100 executes the application file according to the execution state information in step 514. That is, the processor 100 executes the application file corresponding to the file path set in the execution state information by an application program corresponding to an application program type set in the execution state information.

In step 514, if the application file is an application program execution file, the processor 100 executes the application program execution file. In this manner, an application program corresponding to information being displayed at the moment when the screen is captured can be executed for a user, simply by the user's executing of an image file added with execution state information. If the application file is a text file, the processor 100 executes the text file, particularly a page indicated by the execution position set in the execution state information. In this manner, a text file is executed so that a user may view or edit a page opened at a screen capture time, simply by the user's executing of an image file added with execution state information. If the application file is a multimedia content file, the processor 100 executes the multimedia content file and reproduces multimedia content, particularly starting from a reproduction position indicated by the execution position set in the execution state information. In this manner, a multimedia content file is executed so that a user may enjoy multimedia content that was being reproduced at a screen capture time, simply by the user's executing of an image file added with execution state information.

Meanwhile, if execution state information exists for each of a plurality of application files and the application files are all present, the processor 100 executes all of the application files according to the execution state information in steps 510 and 514.

As is apparent from the above description of the present invention, as execution state information about information being displayed at a screen capture time is stored in a file of a captured screen during screen capture, a user can readily execute an application file corresponding to the information being displayed at the screen capture time, later simply by executing the file having the execution state information.

Especially when the application file is a text file, a page that was opened at the screen capture time is reopened. If the application file is a multimedia content file, multimedia content is reproduced, starting from a reproduction position at which the multimedia content was being reproduced at the screen capture time.

Therefore, a user can readily access information that was being displayed at a screen capture time.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the present invention has been particularly shown and described with reference to embodiments thereof, it will be understood by those of ordinary skill in the art that various changes in form and details may be made therein without departing from the spirit and scope of the present invention. For example, while it has been described in an embodiment of the present invention that a user can select application file execution setting in steps 206 and 208 of FIG. 2, steps 206 and 208 may not be performed in real application. In addition, while it has been described in an embodiment of the present invention that a user can select whether to execute an application file in steps 506 and 508 and an error message is output in step 512 in FIG. 5, steps 506, 508, and 512 may not be performed in real implementation.

Therefore, the scope of the invention should be determined by the appended claims and their legal equivalents, not by the above description, and all changes coming within the meaning and equivalency range of the appended claims are intended to be embraced therein.

What is claimed is:

1. A screen capture method for executing an application file, comprising:
capturing a screen that is being displayed and storing the captured screen in a file in response to a screen capture request; and
storing execution state information about an application file corresponding to at least one application window included in the captured screen in the file.

2. The screen capture method of claim 1, wherein the file in which the captured screen is stored is an image file, and the storing of the execution state information comprises adding the execution state information to the image file.

3. The screen capture method of claim 1, wherein the execution state information includes information about a file path and an application program type of the application file.

4. The screen capture method of claim 3, wherein the execution state information further includes information about an execution position of the application file, and wherein if the application file is a text file, the execution position indicates a page that was being displayed during the screen capture request a screen capture time, and if the application file is a multimedia content file, the execution position indicates a position at which multimedia content was being reproduced during the screen capture request.

5. The screen capture method of claim 1, further comprising:
receiving a request for executing the file including execution state information; and
executing the at least one application file according to the execution state information in the file.

6. A screen capture apparatus for executing an application file, comprising:
a display;
a memory; and
a processor for capturing a screen that is being displayed on the display and storing the captured screen in a file in the memory in response to a screen capture request, and storing execution state information about an application file corresponding to at least one application window included in the captured screen in the file.

7. The screen capture apparatus of claim 6, wherein the file in which the captured screen is stored is an image file and the processor adds the execution state information to the image file.

8. The screen capture apparatus of claim 6, wherein the execution state information includes information about a file path and an application program type of the application file.

9. The screen capture apparatus of claim 8, wherein the execution state information further includes information about an execution position of the application file, and wherein if the application file is a text file, the execution position indicates a page that was being displayed during the screen capture request and if the application file is a multimedia content file, the execution position indicates a position at which multimedia content was being reproduced during the screen capture request.

10. The screen capture apparatus of claim 8, wherein the processor executes at least one application file according to the execution state information in response to a request for executing the file including the execution state information.

11. A method for executing an application file, comprising:
receiving a request for executing a file including execution state information; and
executing at least one application file according to the execution state information in the file.

12. The method of claim 11, wherein the file including the execution state information is an image file and the execution state information is added to the image file.

13. The method of claim 12, wherein the execution state information includes information about a file path and an application program type of an application file corresponding to an application window included in a screen obtained by screen-capturing an image of the image file.

14. The method of claim 13, wherein the execution state information further includes information about an execution position of the application file, and
wherein if the application file is a text file, the execution position indicates a page that was being displayed at a screen capture time and the executing comprises opening the page indicated by the execution position.

15. The method of claim 13, wherein the execution state information further includes information about an execution position of the application file, and
wherein if the application file is a multimedia content file, the execution position indicates a position at which multimedia content was being reproduced at a screen capture time and the executing comprises reproducing multimedia content, starting from the reproduction position indicated by the execution position.

16. An apparatus for executing an application file, comprising:
a memory for storing a file including execution state information; and
a processor for executing at least one application file according to the execution state information in response to a request for executing the file including the execution state information.

17. The apparatus of claim 16, wherein the file including the execution state information is an image file and the execution state information is added to the image file.

18. The apparatus of claim 17, wherein the execution state information includes information about a file path and an application program type of an application file corresponding to an application window included in a screen obtained by screen-capturing an image of the image file.

19. The apparatus of claim 18, wherein the execution state information further includes information about an execution position of the application file, and wherein if the application file is a text file, the execution position indicates a page that was being displayed at a screen capture request and the processor opens the page indicated by the execution position.

20. The apparatus of claim 18, wherein the execution state information further includes information about an execution position of the application file, and wherein if the application file is a multimedia content file, the execution position indicates a position at which multimedia content was being reproduced at a screen capture request and the processor reproduces multimedia content, starting from the reproduction position indicated by the execution position.
